(19) United States
(12) Patent Application Publication
(10) Pub. No.: US 2006/0185536 A1
(43) Pub. Date: Aug. 24, 2006

(54) Printing press roll and cylinder

(75) Inventors: Ewald Beer, Augsburg (DE); Ernst Brandner, Pottmes (DE); Max Eder, Mering (DE)

Correspondence Address: COHEN, PONTANI, LIEBERMAN & PAVANE, 551 FIFTH AVENUE, SUITE 1210, NEW YORK, NY, 10176, US

(73) Assignee: MAN Roland Druckmaschinen AG

(21) Appl. No.: 11/317,100

(22) Filed: Dec. 22, 2005

(30) Foreign Application Priority Data
Dec. 22, 2004 (DE) 10 2004 061 669.8

(51) Int. Cl. B41F 5/00

(52) U.S. Cl. 101/216

(57) ABSTRACT

A press pull roll for moving a printing web through a printing press, especially through a folder, includes a roll body which moves the web, and a motor inside the roll body for driving the roll body in rotation. The motor includes a stationary spindle having stator windings, and rotor windings fitted in the roll body. The press pull roll is preferably one of a pair of press pull rolls forming a nip, wherein the second press pull roll may also incorporate a motor, or may be driven by the first press pull roll.

### BACKGROUND OF THE INVENTION

1. Field of the Invention

The invention relates to a printing press pull roll for transporting a printing web through a press, to a pair of printing press pull rolls, and to a folder incorporating a pair of printing press pull rolls. Furthermore, the invention relates to a printing press cylinder.

2. Description of the Related Art

Press pull rolls are used to transport a web printing material through the press and also for web tension regulation. For example, a folder of a web-fed rotary press comprises a plurality of pairs of press pull rolls each comprising two press pull rolls which move the printing material onto a cutting knife cylinder of the folder, starting from a folding former, the web printing material being moved through a nip between the press pull rolls of the pairs of press pull rolls. According to the prior art, the press pull rolls are driven by motors which are arranged and mounted outside the press pull rolls and are coupled to the press pull rolls via toothed belts, couplings and gear mechanisms. This results in a great deal of effort on construction and mounting.

On this basis, the present invention is based on the problem of providing a novel type of press pull roll, a novel type of pair of press pull rolls and a novel type of folder. Furthermore, the present invention is based on the problem of providing a novel type of press cylinder.

### SUMMARY OF THE INVENTION

This problem is solved by a press pull roll wherein the drive is integrated in the press pull roll.

According to an advantageous development of the invention, the press pull roll comprises a stationary spindle, on which a roll body is rotatably mounted, the stationary spindle being assigned stator-side windings and the rotatable roll body being assigned rotor-side windings of the drive configured as an electric motor.

The stationary spindle is preferably tubular, cables from the outside being led through the tubular spindle to the stator-side windings of the drive and/or to further devices integrated in the press pull roll.

The stationary spindle is preferably mounted on only one side on a likewise stationary wall of the press, in particular of the folder, an external diameter and a length of the press pull roll being dimensioned in such a way that a ratio of external diameter to length is large, the external diameter accordingly being dimensioned as large as possible and the length as small as possible.

The pair of press pull rolls according to the invention includes at least one pull roll with an integrated drive, and the folder according to the invention incorporates a pair of pull rolls. The press cylinder according to the invention also has an integrated drive.

Preferred developments of the invention emerge from the following description. Exemplary embodiments of the invention, without being restricted thereto, will be explained in more detail by using the drawings.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a cross section through a press pull roll according to the invention;

FIG. 2 shows a cross section through a pair of press pull rolls according to the invention; and

FIG. 3 shows a cross section through a further pair of press pull rolls according to the invention.

### DETAILED DESCRIPTION OF THE PRESENTLY PREFERRED EMBODIMENTS

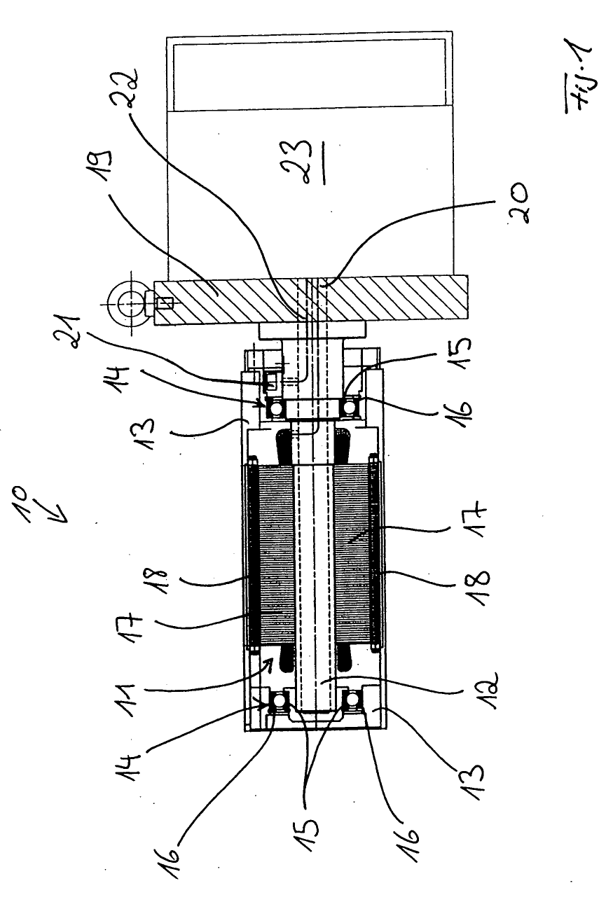

In the following text, the present invention will be described in greater detail with reference to FIGS. 1 to 3.

FIG. 1 shows a cross section through a preferred embodiment of a press pull roll 10 according to the invention. The press pull roll 10 can be, for example, a pull roll for a folder, in order to transport a web printing material. The press roll according to the invention is, however, not restricted to use in a folder. Instead, the press pull roll according to the invention can also be used in other assemblies of a press, for example in turner units, press units, cooling units, web guiding units, delivery units or folder units, including the folder superstructure, folding mechanism and the paddle wheel.

In the spirit of the present invention, a drive 11 for driving the press pull roll 10 is integrated in the press pull roll 10. Thus, in the exemplary embodiment of FIG. 1, the press pull roll 10 is formed by a stationary or stator-side spindle 12, on which a rotating or rotor-side roll body 13 is mounted such that it can rotate. The mounting of the rotor-side roll body 13 on the stator-side spindle 12 in the exemplary embodiment shown is carried out by means of antifriction bearings 14, an inner race 15 of the antifriction bearings 14 being designed to be stationary and an outer race 16 being designed to rotate.

As already mentioned, the drive 11 is integrated in the press pull roll 10 according to the invention. In this case, the drive 11 is preferably designed as an electric motor, stator-side windings 17 of the electric motor being assigned to the stationery, stator-side spindle 12, and rotor-side windings 18 being assigned to the rotating or rotor-side roll body 13. In the exemplary embodiment illustrated, the drive 11 of the press pull roll 10 is accordingly integrated in the press pull roll 10 and is constructed as an external rotor motor, as it is known.

In the exemplary embodiment shown, the stationary or stator-side spindle 12 has a proximal and mounted on a wall 19 of a press. The distal end of the spindle 12 or the press roll 10 opposite the wall 19 is free in space and is accordingly not mounted on a wall. It should be pointed out at this point that, of course, the spindle can also be mounted on both ends on a stationary wall.

In the preferred exemplary embodiment of FIG. 1, in which the stationery or stator-side spindle 12 is fixed to a wall 19 on only one end, an external diameter and a length of the press roll 10 are dimensioned in such a way that the ratio of the length with respect to the external diameter is relatively small, therefore that the length of the press roll is relatively short and the external diameter of the same is relatively large. This makes it possible to enlarge the external diameter of the spindle 12 as well and thus, despite an only one-sided fixing of the spindle 12 to the wall 19, to ensure good rigidity of the spindle 12, in order to minimize the sagging of the latter. Furthermore, with the greatest possible external diameter of the press pull roll 10, the drive 11 of the same configured as an external rotor motor can be configured with many poles, so that a high torque can be achieved at a relatively small nominal rotational speed. Furthermore, with a relatively large external diameter of the press pull roll 10, a diameter of an air gap between the stator-side windings 17 and the rotor-side windings 18 of the drive 11 can also be configured to be large, which means that a lever arm critically influencing the torque can be designed to be at a maximum.

According to a preferred development of the present invention, the spindle 12 of the press pull roll 10 is hollow, at least in some sections, and accordingly tubular. In this case, it is within the spirit of the present invention to lead cables from the outside into the press roll 10 through the tubular spindle 12, for example cables 20 which are used for the power supply of the stator-side windings 17 of the drive 11. Further devices can be integrated in the press pull roll 10, for example, according to FIG. 1, a rotational speed sensor 21. Via the tubular spindle 12, cables 22 can be led from the outside in the direction of the rotational speed sensor 21, in order to supply the same with power and/or in order to transmit measured signals determined by the rotational speed sensor 21 to a control device 23 of the press pull roll 10. Moreover, further devices can be integrated in the press pull roll 10, for example a temperature sensor.

The control device 23 is fixed to an opposite side of the wall 19 from as the spindle 12 of the press pull roll 10. Integrated in the control device 23 are all the devices for controlling or regulating the rotational speed of the press pull roll 10 in operation. These subassemblies can be sensors, invertors, controllers, supply units and further electrical and electronic subassemblies.

In the spirit of the present invention, a coolant can also be led into the press pull roll 10 through the tubular spindle 12 of the press pull roll 10 in order during operation to cool subassemblies which are integrated in the press pull roll 10. The coolant is in this case led into the press pull roll 10 from outside via coolant lines and, after cooling the relevant subassemblies, is led out of the press pull roll 10 again.

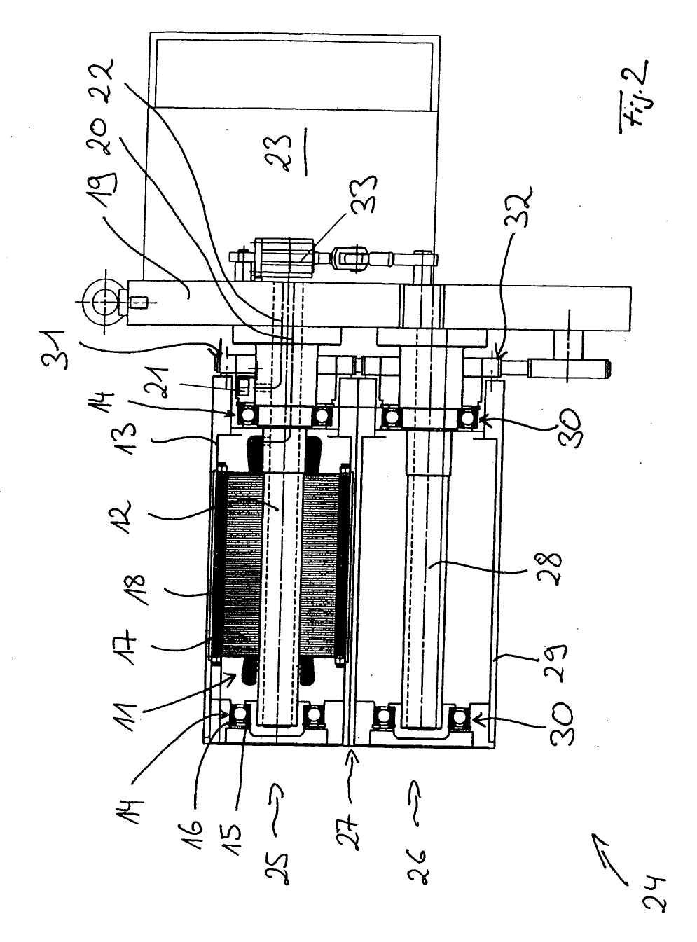

FIG. 2 shows a pair of press pull rolls 24 according to the invention comprising two press pull rolls 25 and 26, a nip 27 being formed between the press pull rolls 25 and 26, through which nip a web printing material can be led in order to transport the same through a press.

In the exemplary embodiment of FIG. 2, a drive is integrated in one of the press pull rolls, namely the upper press pull roll 25, whereas the lower press pull roll 26 is driven by the upper press pull roll 25. The upper press pull roll 25 of the exemplary embodiment of FIG. 2 corresponds in its construction to the press pull roll 10 of FIG. 1, so that the same reference numbers have been used here for the same subassemblies. In order to avoid unnecessary repetition, reference is therefore made to the explanations relating to the press pull roll 10 with regard to the details of the press pull roll 25.

The upper press pull roll 25, in which the drive 11 is integrated, is mounted on the wall 19 of the press in a stationary position via the tubular spindle 12. The lower press pull roll 26 is driven by the upper press pull roll 25. Thus, FIG. 2 shows that the press pull roll 26 driven by the press pull roll 25 has only a stationary or stator-side spindle 28 and a rotating or rotor-side roll body 29, the rotor-side roll body 29 being rotatably mounted on the stator-side spindle 28 via antifriction bearings 30. On the rotor-side roll bodies 13 and 29 of the two press pull rolls 25 and 26 there engage gear wheels 31 and 32, which mesh with each other and rotate together with the respective roll body 13 and 29. In this way, the rotation of the roll body 13 of the press pull roll 25, which is effected by the drive 11 integrated in the latter, can be transmitted to the roll body 29 of the press pull roll 26.

The lower press pull roll 26 of the pair of press pull rolls 24 is not fixed to the wall 19 in a fixed location, as distinct from the upper press pull roll 25, but instead is mounted such that it can be displaced or adjusted. Thus, an adjusting device 33 acts on the spindle 28 of the lower press pull roll 26, with the aid of which the lower press pull roll 26 can be displaced in the radial direction relative to the upper, fixed-location press pull roll 25, in order in this way to adapt the nip 27 between the two press pull rolls 25 and 26, for example to varying thicknesses of a printing material to be transported.

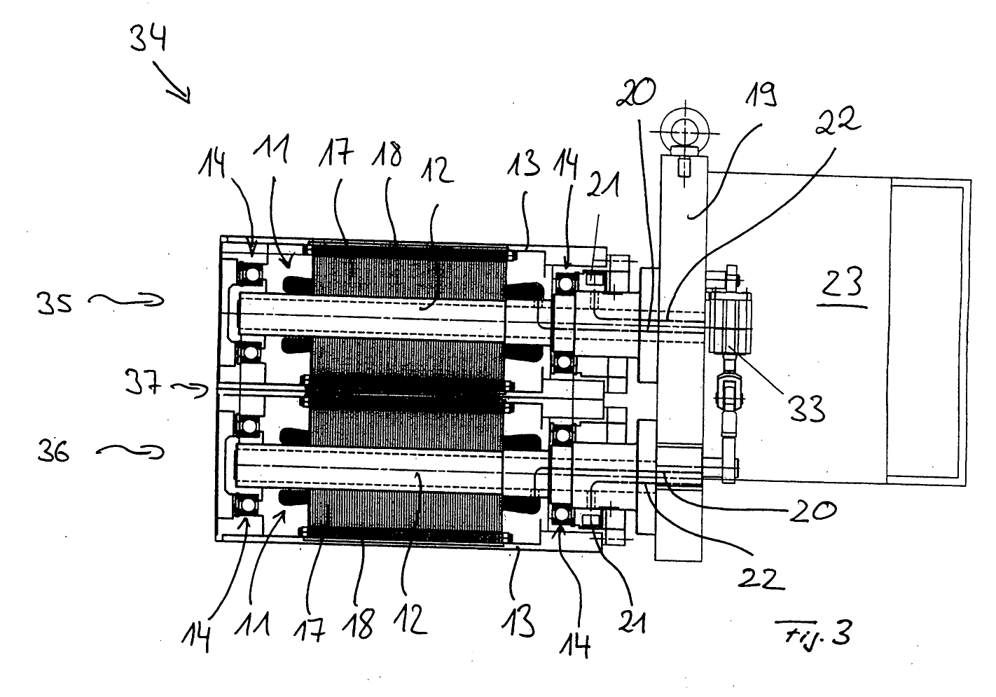

A further exemplary embodiment of a pair of press pull rolls 34, which is formed by two press pull rolls 35 and 36, is shown by FIG. 3. Once more, a nip 37 is formed between the press pull rolls 35 and 36 of the pair of press pull rolls 34 of FIG. 3, in order to move a printing material between press pull rolls 35 and 36 of the pair of press pull rolls 34 and thus to transport it through a press. In the exemplary embodiment of FIG. 3, a drive 11 is integrated in each press pull roll 35 and 36 of the pair of press pull rolls 34. Accordingly, with regard to their construction, the two press pull rolls 35 and 36 correspond to the press pull roll 10 of FIG. 1, so that, here too, the same reference symbols are again used for the same subassemblies in order to avoid unnecessary repetitions. Accordingly, the exemplary embodiment of FIG. 3 differs from the exemplary embodiment of FIG. 2 only in the fact that, in the exemplary embodiment of FIG. 3, in each case a drive 11 is integrated in both press pull rolls 35 and 36, so that both press pull rolls 35 and 36 are driven by individual motors and thus activated by the control device 23.

Both in the exemplary embodiment of FIG. 2 and in the exemplary embodiment of FIG. 3, both press pull rolls of the pairs of press pull rolls 24 and 34 can be driven either at the same circumferential speed or at different circumferential speeds. Driving the press pull rolls of a pair of press pull rolls at different circumferential speeds is advantageous when the two press pull rolls are wrapped around to different extents by the printing material to be transported. A rotational speed difference between the press pull rolls of a pair of press pull rolls accordingly depends on the extent to which the web printing material wraps around the same. Press pull rolls which are wrapped around to a greater extent by the printing material to be transported can thus be driven at a lower rotational speed than a press pull roll with a smaller wrap. The rotational speed difference or differential speed between the press pull rolls of a pair of press pull rolls can also depend on the thickness of the printing material to be transported.

In the spirit of the present invention, it is possible for a control algorithm for the drives 11 to be integrated in the control device 23, motor currents of the drives formed as external rotor motors being used as input variables for the control algorithm, in order to regulate the rotational speeds of the press pull rolls during operation. Conversely, it is also possible for the rotational speeds of the press pull rolls to serve as input variables and for the motor currents of the drives to be regulated.

As already mentioned, the tubular and therefore internally hollow spindles can be used for the purpose of cooling the subassemblies integrated in the press pull rolls. If the dissipation of heat by radiation is sufficient, it is also possible to dispense with such cooling. For example, some of the heat is carried away by the printing material web to be transported between the press pull rolls of a pair of press pull rolls. Further dissipation of heat is carried away by the air wedge running between the two press pull rolls of a pair of press pull rolls. If the introduction of coolant into the press pull rolls is dispensed with, but the dissipation of heat by radiation is not sufficient, then, for example, a fan impeller can be mounted on the wall 19 outside the press pull rolls, which impeller revolves together with the press pull rolls and produces a specific air stream along the surface of the roll bodies, in order in this way to assist the dissipation of heat. However, it is also possible to lead a cooling medium, for example air or water, into the press pull rolls via the tubular spindle of the press pull rolls and to use it for cooling.

As a result of the integration of drives in press pull rolls, the design and construction of the same is simplified, since it is possible to dispense with toothed belts and couplings for driving the press pull rolls. It is likewise possible to dispense with a motor fixing, bracket and cladding. The mounting effort is reduced considerably. Each press pull roll of a pair of press pull rolls can be driven at an individual rotational speed or circumferential speed. By means of the invention, a modular design in the form of a building block system is made possible, which means that, in the event of service, a complete module can be replaced, in order in this way to reduce service times and downtimes.

The press pull rolls and pairs of press pull rolls according to the invention are preferably used in folders of a web-fed rotary press and are used there for transporting a web printing material from a folding former in the direction of a cutting knife cylinder. The press pull rolls or pairs of press pull rolls of the present invention can, however, also be used at other installation locations or in other units of a press, for example in turner units, press units, cooling units, web guiding units, delivery units or folding units, including the folder superstructure, folding mechanism and the paddle wheel.

In addition, the invention can be used in a press cylinder, specifically a forme cylinder and/or an impression cylinder of a printing unit. In this case, a drive is integrated in the forme cylinder and/or the impression cylinder, the respective cylinder having a stationary spindle on which a cylinder body is rotatably mounted and the stationary spindle being assigned stator-side windings and the rotatable cylinder body being assigned rotor-side windings of the drive configured as an electric motor. With regard to the remaining details, reference can be made to the explanations which were given with reference to FIGS. 1 to 3 for a press pull roll and a pair of press pull rolls.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A press pull roll for moving a printing web through a printing press, the pull roll comprising:
a roll body which moves the web; and
a motor inside the roll body for driving the roll body in rotation.

2. The press pull roll of claim 1 wherein the motor comprises:
a stationary spindle having stator windings;
rotor windings fitted in the roll body.

3. The press pull roll of claim 2 wherein the stationary spindle is a tubular spindle.

4. The press pull roll of claim 3 further comprising electrical cables extending into the tubular spindle to the stator windings.

5. The press pull roll of claim 3 further comprising electrical cables extending into the tubular spindle to devices comprising at least one of a rotational speed sensor and a temperature sensor.

6. The press pull roll of claim 3 further comprising coolant lines extending into the tubular spindle.

7. The press pull roll of claim 2 wherein the stationary spindle has a proximal end fixed to a stationary wall of the press.

8. The press pull roll of claim 1 wherein the roll body has an external diameter and a length, the ratio of the external diameter to the length being greater than 1:1.

9. A pair of press pull rolls comprising
a first press pull roll comprising a roll body and a motor inside the roll body for driving the roll body in rotation; and
a second press pull roll positioned in parallel with the first press pull roll to form a nip in which the web is guided in order to move the web through the press.

10. The pair of press pull rolls of claim 9 wherein the second press pull roll is driven in rotation by the first press pull roll.

11. The pair of press pull rolls of claim 9 wherein the second press pull roll comprises a roll body and a motor inside the roll body for driving the roll body in rotation.

12. The pair of press pull rolls of claim 9 wherein the motor comprises a stationary spindle having stator windings, and rotor windings fitted in the roll body.

13. The pair of press pull rolls of claim 9 wherein the first press pull roll is mounted in a fixed location on a stationary wall of the press, and the second press pull roll is mounted on the stationary wall so that it can be displaced in order to adjust the nip.

14. The pair of press pull rolls of claim 9 wherein the first and second press pull rolls can be driven at different speeds.

15. The pair of press pull rolls of claim 14 wherein the difference in speeds depends on the effective diameter of the rolls and the thickness of the web.

16. The printing press cylinder of claim 13 wherein the stationary wall is the wall of a folder of the press.

17. A printing press cylinder which is one of a forme cylinder and an impression cylinder of a printing unit, the cylinder comprising:
a cylinder body which moves the web; and
a motor inside the roll body for driving the cylinder body in rotation.

18. The printing press cylinder of claim 17 wherein the motor comprises:
a stationary spindle having stator windings; and
rotor windings fitted in the cylinder body.

19. The printing press cylinder of claim 18 wherein the stationary spindle is a tubular spindle, the press cylinder further comprising at least one of electrical cables and coolant lines extending into the tubular spindle.
